(19) United States
(12) Patent Application Publication
(10) Pub. No.: US 2024/0251992 A1
(43) Pub. Date: Aug. 1, 2024

(54) Food Grilling Device

(71) Applicant: Arthur Brown, Houston, TX (US)

(72) Inventor: Arthur Brown, Houston, TX (US)

(21) Appl. No.: 18/104,608

(22) Filed: Feb. 1, 2023

(51) Int. Cl. A47J 37/07

(52) U.S. Cl. CPC A47J 37/0786

(57) ABSTRACT

A food grilling device for clamping food items for grilling includes a clamping module, which is complementarily to a cooking grid of a grill. The clamping module can be positioned upon or removably replace the cooking grid. The clamping module comprises first and second handles to which is attached a pair of grates. At least one grate is hingable relative to the first handle. The grates are selectively positionable in open and closed configurations, wherein one grate extends angularly from the other and wherein the grates are substantially parallel planar, respectively. The second handle is hingedly attached to one grate and is selectively attachable to the other grate. The clamping module thus can clamp onto a food item with the first and second handles enabling a user to flip the clamping module and the food item, as needed.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to grilling devices and more particularly pertains to a new grilling device for clamping food items for grilling. The present invention discloses a grilling device that allows a user to clamp a food item between a pair of grates and to flip the grates and the food item with handles.

### (2) Description of Related Art Including Information Disclosed Under 37 CFR 1.97 and 1.98

The prior art relates to grilling devices, which may comprise baskets that fully enclose a food item and which are attached to rotary devices for rotating or flipping the food item within a grill. Such baskets must necessarily have a circumference smaller than a cooking grid of the grill to allow for rotation. What is lacking in the prior art is a grilling device comprising a pair of grates that are hingedly attached by a first handle. A food item is positionable between the grates, which then can be fixedly positioned by means of a second handle. The pair of grates is sized to either substantially cover or to replace a cooking grid of a grill.

### BRIEF SUMMARY OF THE INVENTION

An embodiment of the disclosure meets the needs presented above by generally comprising a clamping module, which is sized and shaped substantially complementarily to a cooking grid of a grill. The clamping module is configured for at least one of positioning upon or removably replacing the cooking grid. The clamping module comprises a pair of grates, a first handle, and a second handle. The first handle is attached to the pair of grates, with at least one grate being hingable. Thus configured, the grates are selectively positionable in an open configuration and a closed configuration. In the open configuration, one grate extends angularly from the other grate. In the closed configuration, the grates are substantially parallel planar. The second handle is hingedly attached to one grate and is selectively attachable to the other grate. The second handle is substantially opposingly positioned to the first handle upon attachment to the other grate. The clamping module thus is configured to clamp onto a food item. The first handle and the second handle are configured to be grasped in hands of a user, positioning the user to flip the clamping module and the food item, as needed.

Another embodiment of the disclosure includes a food grilling system, which comprises a clamping module, as per the disclosure above, a grill and a food item. The clamping module is sized and shaped substantially complementarily to and is positioned upon a cooking grid of the grill. The food item is positioned between the grates so that the clamping module is clamped onto the food item. The first and second handles are configured to be grasped in hands of a user, positioning the user to flip the clamping module and the food item, as needed.

Yet another embodiment of the disclosure includes a method of grilling a food item comprising provision steps, which entail providing a grill and a food item along with a food grilling device, as per the disclosure above. A preparatory step is firing up the grill. Operational steps are hinging the grates to the open configuration, positioning the food item between the grates, hinging the grates to the closed configuration, and attaching the second handle so that the clamping module is clamped onto the food item. Grilling steps of the method are positioning the clamping module and the food item on the cooking grid and, as needed, grasping the first and second handles and flipping the clamping module and the food item.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a food grilling device according to an embodiment of the disclosure.

FIG. 2 is a top isometric perspective view of an embodiment of the disclosure.

FIG. 3 is a bottom isometric perspective view of an embodiment of the disclosure.

FIG. 4 is a side view of an embodiment of the disclosure.

FIG. 5 is a cross-sectional view of an embodiment of the disclosure.

FIG. 6 is an isometric perspective view of an embodiment of the disclosure.

FIG. 7 is a cross-sectional in-use view of an embodiment of the disclosure.

FIG. 8 is an in-use view of an embodiment of the disclosure.

FIG. 9 is a flow diagram for a method utilizing an embodiment of the disclosure.

### DETAILED DESCRIPTION OF THE INVENTION

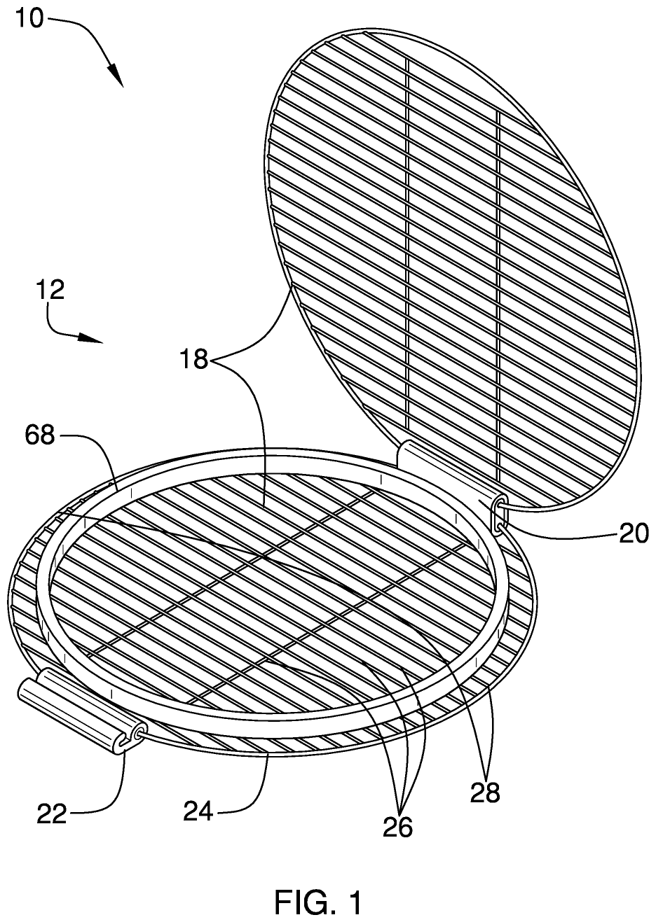

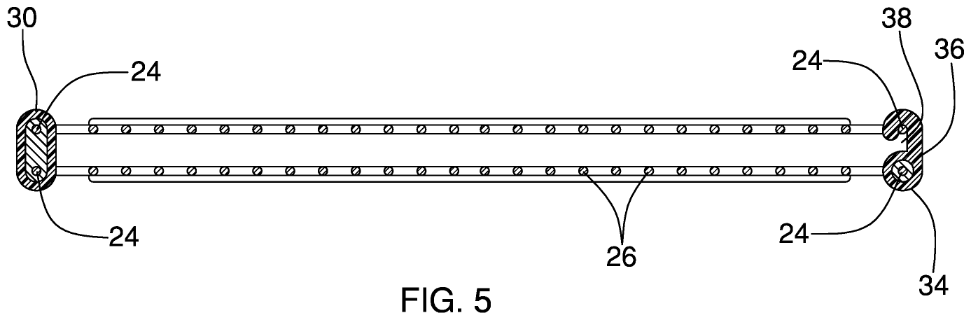

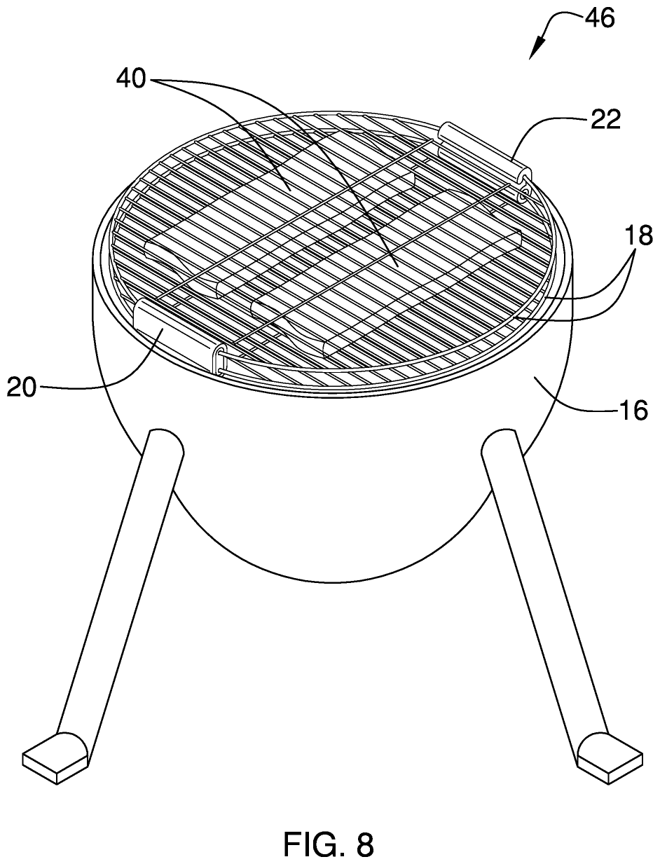

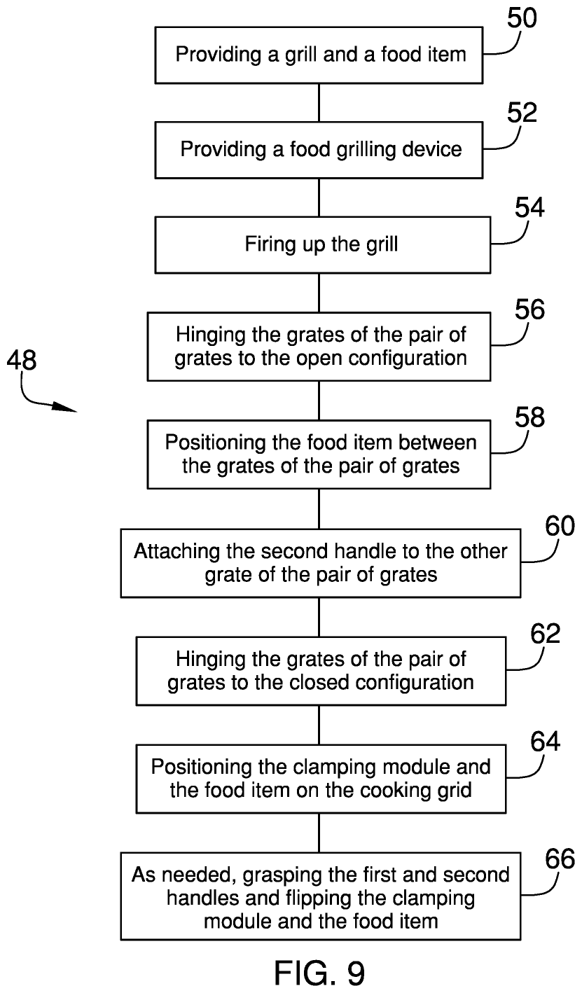

With reference now to the drawings, and in particular to FIGS. 1 through 9 thereof, a new grilling device embodying the principles and concepts of an embodiment of the disclosure and generally designated by the reference numeral 10 will be described.

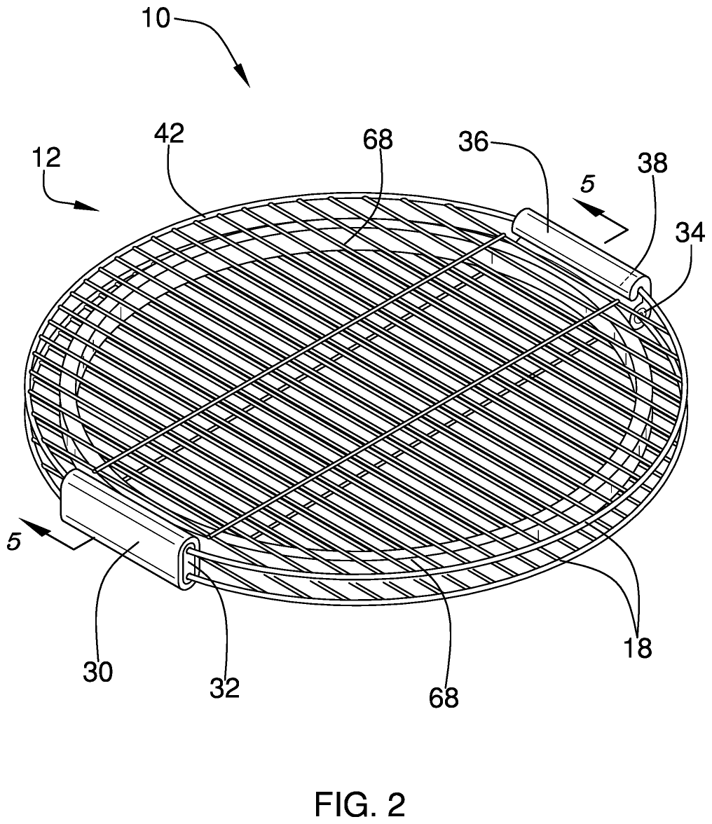

As best illustrated in FIGS. 1 through 9, the food grilling device 10 generally comprises a clamping module 12, which is sized and shaped substantially complementarily to a cooking grid 14 of a grill 16, such as, but not limited to, a barbeque grill, a smoker, or the like. The clamping module 12 is configured for at least one of positioning upon or removably replacing the cooking grid 14. The clamping module 12 comprises a pair of grates 18, a first handle 20, and a second handle 22. Each grate 18 comprises a ring 24 and a plurality of crosspieces 26. The ring 24 may be substantially circular, as shown in FIG. 2, rectangular, ovoid, or the like. Each crosspiece 26 is attached by its opposed ends 28 to the ring 24.

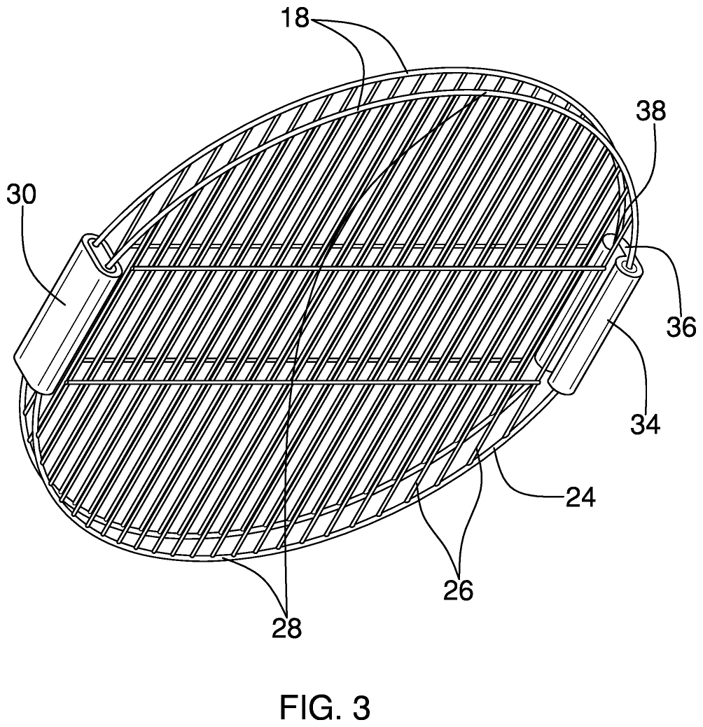

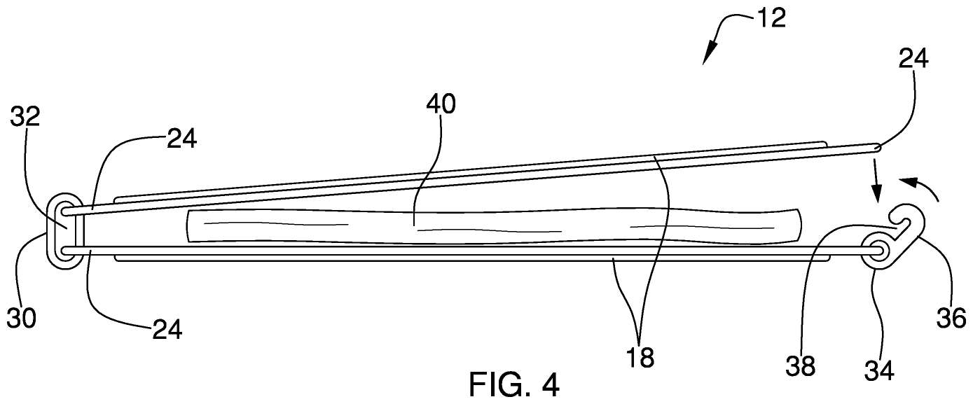

The first handle 20 is attached to the pair of grates 18, with at least one grate 18 being hingable relative to the first handle 20 and the other grate 18. As shown in FIGS. 3 and 4, the first handle 20 comprises a first tube 30, which is positioned around the ring 24 of each grate 18 so that both grates 18 are hingedly attached to the first handle 20. The first tube 30 has a cross-sectional profile 32, which may be ovoid, as shown in FIG. 4, rectangular, or the like. Other attachment means for the first handle 20 are anticipated by the present invention, such as a plate to which the grates 18 are attached with one or both of the grates 18 being hingedly attached, a plurality of O-rings, or the like. Thus configured, the grates 18 are selectively positionable in an open configuration, as shown in FIG. 1, and a closed configuration, as shown in FIG. 2. In the open configuration, one grate 18 extends angularly from the other grate 18. In the closed configuration, the grates 18 are substantially parallel planar.

The second handle 22 is hingedly attached to one grate 18 and is selectively attachable to the other grate 18. As shown in FIGS. 3-5, the second handle 22 comprises a second tube 34, which is positioned around the ring 24 of the one grate 18 of the pair of grates 18. A plate 36 is attached to and extends arcuately from the second tube 34, thereby defining a slot 38. The slot 38 is positioned for selective insertion, of a snap fit type, of the ring 24 of the other grate 18 to attach the second handle 22 to the other grate 18. The second handle 22 thus reversibly fixes the grates 18 in the closed configuration. A food item 40 that is positioned between the grates 18 would exert an outward pressure on the grates 18 and help to secure them in the closed configuration. Other, means for fixing the grates 18 in the closed configuration are anticipated by the present invention, such as, but not limited to clamps, hooks, or the like.

The clamping module 12 thus is configured to clamp onto the food item 40. The second handle 22 is substantially opposingly positioned to the first handle 20 upon attachment to the other grate 18. The first handle 20 and the second handle 22 are configured to be grasped in hands of a user, positioning the user to flip the clamping module 12 and the food item 40, as needed. Upon partially cooking the food item 40, the first handle 20 and the second handle 22 would be hot to the touch. It thus is anticipated that the user would use oven mitts, leather gloves, or the like, for grasping the first handle 20 and the second handle 22.

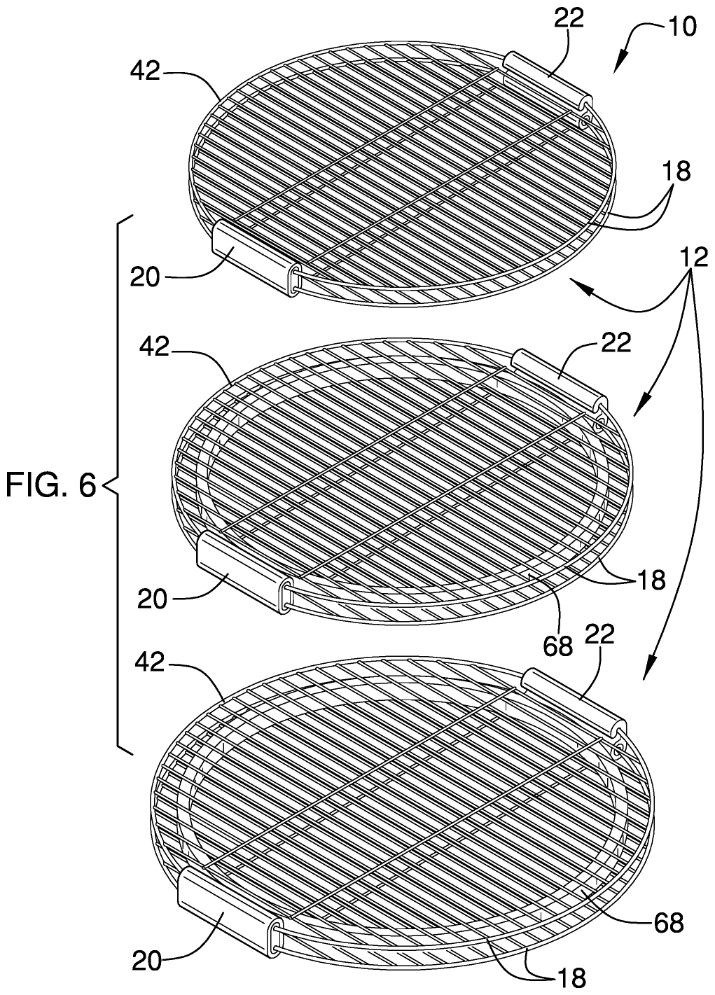

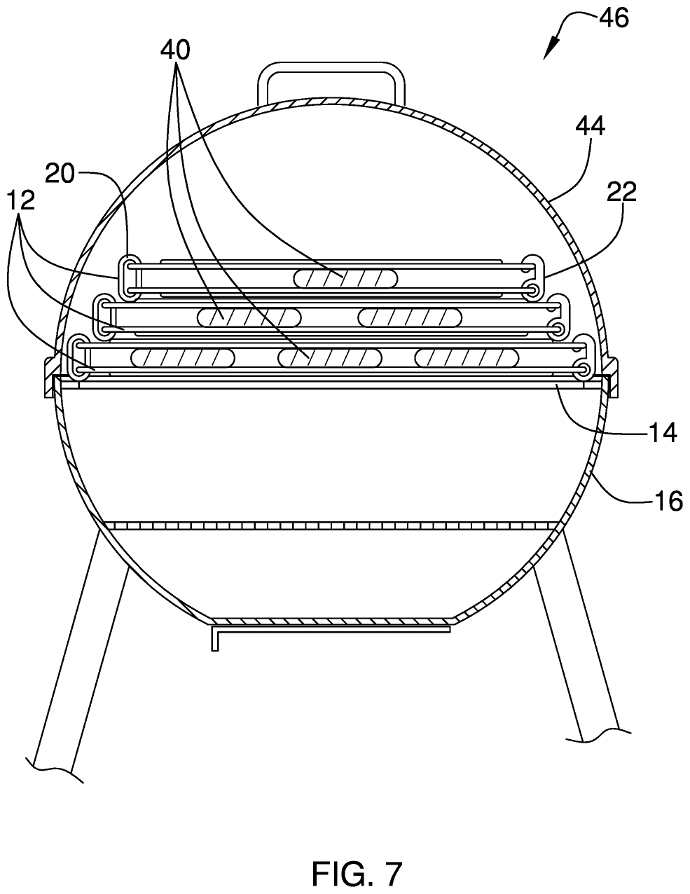

As shown in FIGS. 6 and 7, the clamping module 12 is one of a plurality of clamping modules 12. One clamping module 12 is configured for at least one of positioning upon or removably replacing the cooking grid 14. The remaining clamping modules 12 are configured to be selectively stacked upon the one clamping module 12.

As shown in FIG. 2, the clamping module 12 also may comprise a vertical element 68, which is attached to one of the grates 18 which abuts the other of the grates 18 when the grates 18 are in the closed configuration. The vertical element 68 provides structural support to the clamping modules 12 to facilitate their stacking without requiring a food item 40 to support a mass of a clamping module 12 positioned above the clamping module 12 that is clamped to the food item 40. The present invention anticipates the vertical element 68 extending circumferentially around the grate 18 and being positioned proximate to a circumference 42 of the clamping module 12. The vertical element 68 thus would encircle smaller items, such as hotdogs, sausages, or the like, that are positioned between the pair of grates 18 and would prevent them from falling out of the clamping module 12 as it is being flipped.

Each clamping module 12 has a respective circumference 42 so that the plurality of clamping modules 12 comprises clamping modules 12 that have a variety of circumferences 42. As discussed above, at least one clamping module 12 has a circumference 42 allowing it to be either positioned upon or to removably replace the cooking grid 14. The remaining clamping modules 12 are configured to be selectively stacked upon the one clamping module 12 based on their respective circumferences 42. Thus, the plurality of clamping modules 12 is configured to fit within a lid 44 of the grill 16. The plurality of clamping modules 12 may comprise three clamping modules 12, as shown in FIGS. 6 and 7, although the present invention also anticipates the plurality of clamping modules 12 comprising two or four clamping modules 12.

The present invention anticipates a food grilling system 46, which comprises a clamping module 12, as per the specification above, a grill 16 and a food item 40. The clamping module 12 is sized and shaped substantially complementarily to, and is positioned upon, a cooking grid 14 of the grill 16. The food item 40 is positioned between the grates 18 so that the clamping module 12 is clamped onto the food item 40. The first handle 20 and the second handle 22 are configured to be grasped in hands of a user, positioning the user to flip the clamping module 12 and the food item 40, as needed.

The food grilling system 46 also anticipates the grill 16 comprising a lid 44, the food item 40 being one of a plurality of food items 40, and the clamping module 12 being one of a plurality of clamping modules 12, which each clamping module 12 being clamped onto one or more of the food items 40. As shown in FIGS. 6 and 7, each clamping module 12 has a respective circumference 42 so that the plurality of clamping modules 12 comprises clamping modules 12 having a variety of circumferences 42. One clamping module 12 is sized and shaped substantially complementarily to and is positioned upon the cooking grid 14. The remaining clamping modules 12 are stacked upon the one clamping module 12, based on their respective circumferences 42, so that the lid 44 is positioned to selectively cover the plurality of clamping modules 12.

In use, the food grilling device 10 enables a method of grilling a food item 48, which comprises a first provision step 50 that entails providing a grill 16 and a food item 40. A second provision step 52 of the method 48 is providing a food grilling device 10, as per the specification above. A preparatory step 54 of the method 48 is firing up the grill 16. A first operational step 56 of the method 48 is hinging the grates 18 to the open configuration. A second operational step 58 of the method 48 is positioning the food item 40 between the grates 18. A third operational step 60 of the method 48 is hinging the grates 18 to the closed configuration. A fourth operational step 62 of the method 48 is attaching the second handle 22 to the other grate 18 so that the clamping module 12 is clamped onto the food item 40. A first grilling step 64 of the method 48 is positioning the clamping module 12 and the food item 40 on the cooking grid 14. A second grilling step 66 of the method 48 is, as needed, grasping the first handle 20 and the second handle 22 and flipping the clamping module 12 and the food item 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food grilling device comprising a clamping module sized and shaped substantially complementarily to a cooking grid of a grill, wherein the clamping module is configured for at least one of positioning upon or removably replacing the cooking grid, the clamping module comprising:
a pair of grates;
a first handle attached to the pair of grates, at least one grate of the pair of grates being hingedly attached to the first handle, such that the grates of the pair of grates are selectively positionable in an open configuration, wherein one grate of the pair of grates extends angularly from the other grate of the pair of grates, and a closed configuration, wherein the grates of the pair of grates are substantially parallel planar; and
a second handle hingedly attached to one grate of the pair of grates and selectively attachable to the other grate of the pair of grates, such that the second handle is substantially opposingly positioned to the first handle upon attachment to the other grate of the pair of grates, wherein the clamping module is configured for clamping onto a food item and wherein the first handle and the second handle are configured for grasping in hands of a user, positioning the user for flipping the clamping module and the food item.

2. The food grilling device of claim 1, wherein each grate of the pair of grates comprises:
a ring; and
a plurality of crosspieces, each crosspiece of the plurality of crosspieces having opposed ends attached to the ring.

3. The food grilling device of claim 2, wherein the ring is substantially circular.

4. The food grilling device of claim 1, wherein both grates of the pair of grates are hingedly attached to the first handle.

5. The food grilling device of claim 1, wherein the first handle comprises a first tube positioned around the ring of each grate of the pair of grates, such that both grates of the pair of grates are hingedly attached to the first handle.

6. The food grilling device of claim 5, wherein the first tube has a cross-sectional profile, the cross-sectional profile being ovoid.

7. The food grilling device of claim 5, wherein the second handle comprises:
a second tube positioned around the ring of the one grate of the pair of grates; and
a plate attached to and extending arcuately from the second tube defining a slot, such that the slot is positioned for selective insertion of the ring of the other grate of the pair of grates for attaching the second handle to the other grate of the pair of grates and reversibly fixing the grates of the pair of grates in the closed configuration.

8. The food grilling device of claim 1, further including a vertical element attached to one of the grates and abutting the other of the grates when the pair of grates is in the closed configuration, the vertical element extending circumferentially around the grate proximate to a circumference of the clamping module, wherein the vertical element is configured for encircling smaller food items positioned between the pair of grates for preventing the smaller food items from falling out of the clamping module as the clamping module is being flipped.

9. The food grilling device of claim 1, further including the clamping module being one of a plurality of clamping modules, wherein one clamping module of the plurality of clamping modules is configured for at least one of positioning upon or removably replacing the cooking grid and wherein the remaining clamping modules of the plurality of clamping modules are configured for selective stacking upon the one clamping module of the plurality of clamping modules.

10. The food grilling device of claim 9, wherein each clamping module of the plurality of clamping modules has a respective circumference, such that the plurality of clamping modules comprises clamping modules having a variety of circumferences, wherein one clamping module of the plurality of clamping modules is configured for at least one of positioning upon or removably replacing the cooking grid, wherein the remaining clamping modules of the plurality of clamping modules are configured for selective stacking upon the one clamping module of the plurality of clamping modules, and wherein the plurality of clamping modules is configured for fitting within a lid of the grill.

11. The food grilling device of claim 10, wherein the plurality of clamping modules comprises three clamping modules.

12. The food grilling device of claim 1, further including:
each grate of the pair of grates comprises:
a ring, the ring being substantially circular, and
a plurality of crosspieces, each crosspiece of the plurality of crosspieces having opposed ends attached to the ring;
a vertical element attached to one of the grates and abutting the other of the grates when the pair of grates is in the closed configuration, the vertical element extending circumferentially around the grate proximate to a circumference of the clamping module, wherein the vertical element is configured for encircling smaller food items positioned between the pair of grates for preventing the smaller food items from falling out of the clamping module as the clamping module is being flipped;
the first handle comprises a first tube positioned around the ring of each grate of the pair of grates, such that both grates of the pair of grates are hingedly attached to the first handle, the first tube having a cross-sectional profile, the cross-sectional profile being ovoid;
the second handle comprises:
a second tube positioned around the ring of the one grate of the pair of grates, and
a plate attached to and extending arcuately from the second tube defining a slot, such that the slot is positioned for selective insertion of the ring of the other grate of the pair of grates for attaching the second handle to the other grate of the pair of grates and reversibly fixing the grates of the pair of grates in the closed configuration; and
the clamping module is one of a plurality of clamping modules comprising three clamping modules, each clamping module of the plurality of clamping modules has a respective circumference, such that the plurality of clamping modules comprises clamping modules having a variety of circumferences, wherein one clamping module of the plurality of clamping modules is configured for at least one of positioning upon or removably replacing the cooking grid, wherein the remaining clamping modules of the plurality of clamping modules are configured for selectively stacking upon the one clamping module of the plurality of clamping modules, and wherein the plurality of clamping modules is configured for fitting within a lid of the grill.

13. A food grilling system comprising:
a grill comprising a cooking grid;
a clamping module sized and shaped substantially complementarily to and positioned upon the cooking grid, the clamping module comprising:
a pair of grates,
a first handle attached to the pair of grates, at least one grate of the pair of grates being hingedly attached to the first handle, such that the grates of the pair of grates are selectively positionable in an open configuration, wherein one grate of the pair of grates extends angularly from the other grate of the pair of grates, and a closed configuration, wherein the grates of the pair of grates are substantially parallel planar, and
a second handle hingedly attached to one grate of the pair of grates and selectively attachable to the other grate of the pair of grates, such that the second handle is substantially opposingly positioned to the first handle upon attachment to the other grate of the pair of grates; and
a food item positioned between the grates of the pair of grates, such that the clamping module is clamped onto the food item, wherein the first handle and the second handle are configured for grasping in hands of a user, positioning the user for flipping the clamping module and the food item.

14. The food grilling system of claim 13, wherein:
the grill comprises a lid;
the food item is one of a plurality of food items;
the clamping module is one of a plurality of clamping modules, each clamping module of the plurality of clamping modules being clamped onto one or more of the food items of the plurality of food items; and
each clamping module of the plurality of clamping modules has a respective circumference, such that the plurality of clamping modules comprises clamping modules having a variety of circumferences, one clamping module being sized and shaped substantially complementarily to and positioned upon the cooking grid, the remaining clamping modules of the plurality of clamping modules being stacked upon the one clamping module of the plurality of clamping modules, such that the lid is positioned to selectively cover the plurality of clamping modules.

15. A food grilling method comprising the steps of:
providing a grill and a food item;
providing a food grilling device comprising a clamping module sized and shaped substantially complementarily to a cooking grid of a grill, the clamping module comprising:
a pair of grates,
a first handle attached to the pair of grates, at least one grate of the pair of grates being hingedly attached to the first handle, such that the grates of the pair of grates are selectively positionable in an open configuration, wherein one grate of the pair of grates extends angularly from the other grate of the pair of grates, and a closed configuration, wherein the grates of the pair of grates are substantially parallel planar, and
a second handle hingedly attached to one grate of the pair of grates and selectively attachable to the other grate of the pair of grates, such that the second handle is substantially opposingly positioned to the first handle upon attachment to the other grate of the pair of grates;
firing up the grill;
hinging the grates of the pair of grates to the open configuration;
positioning the food item between the grates of the pair of grates;
hinging the grates of the pair of grates to the closed configuration;
attaching the second handle to the other grate of the pair of grates, such that the clamping module is clamped onto the food item;
positioning the clamping module and the food item on the cooking grid; and
as needed, grasping the first handle and the second handle and flipping the clamping module and the food item.
